(19) United States
(12) Patent Application Publication
(10) Pub. No.: US 2007/0075559 A1
(43) Pub. Date: Apr. 5, 2007

(54) CONSOLE ASSEMBLY HAVING INTEGRATED MEDIA STORAGE

(75) Inventor: Alan Sturt, West Bloomfield, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/163,041

(22) Filed: Oct. 3, 2005

(51) Int. Cl. B60N 3/12

(52) U.S. Cl. 296/37.8

(57) ABSTRACT

A console assembly for use in a passenger seating area of a vehicle includes a console configured for installment in the passenger seating area having a storage cavity defined therein. An armrest pivotally connected to the console housing is movable between a first position extending at least partially over a top surface of the console housing and at least one opened position. A storage module disposed at least partially within the storage cavity includes a housing having at least one storage area configured to receive and secured removable media storage cases. The at least one storage area includes a plurality of slots and at least one spring member which cooperate to store and present the removable media storage cases when the armrest is positioned relative to the storage module.

### BACKGROUND OF THE INVENTION

1. Field of the Invention

The present invention relates generally to a console assembly for a passenger seating area of a vehicle.

2. Background Art

Vehicle manufacturers continue to develop storage containers and devices for the passenger compartments of vehicles to accommodate occupant's personal items and automotive components. Several current storage containers are designed to fit within specified areas of the passenger compartment and allow limited access to items stored therein.

Many automotive vehicles include a center console or other storage device disposed between the driver and passenger seats in the front passenger compartment of the vehicle. These consoles typically comprise a console base either secured to the floor or pivotally connected between the seats, a storage cavity formed in the console base to retain items during travel and an armrest pivotally connected to the console base extending generally horizontally across the storage cavity.

Most consoles include storage areas designed to receive and secure media such as compact discs stored in jewel boxes or cases. Common media storage area designs require sufficient spacing to be incorporated into the arrangement to allow a user to remove the media cases from the storage area. This arrangement increases the total space devoted to the storage area, limiting valuable space in the console assembly. Additionally, dampening materials may be overlayed on the storage area to reduce noise generated by the media cases during vehicle operation, thereby requiring additional area to be devoted to the storage area and increasing the overall cost of the console assembly. It would be advantageous to provide a console assembly having a storage area for media which eliminates the limitations of prior art storage arrangements.

### SUMMARY OF THE INVENTION

The present invention provides a console assembly configured for installment and use in a passenger seating area of a vehicle. The console assembly includes a console housing having a storage cavity defined therein. An armrest is pivotally connected to the console housing and movable between a first position extending at least partially over a top surface of the console housing and at least one opened position.

A storage module disposed at least partially within the storage cavity includes a housing having at least one storage area configured to receive and secured removable media storage cases. The at least one storage area includes a plurality of slots and at least one spring member which cooperate to store and present the removable media storage cases when the armrest is positioned relative to the storage module.

Other features and advantages of the present invention will be readily appreciated and better understood after reading the subsequent description when considered in connection with the accompanying drawings.

### BRIEF DESCRIPTION OF THE DRAWINGS

FIG. 1 is a rear perspective view of a console assembly for a passenger seating area of a vehicle in accordance with the present invention;

FIG. 2 is a front perspective view of the console assembly;

FIG. 3 is a front perspective view of the console assembly with the armrest pivoted upward to allow access to the console storage area;

FIG. 4 is a cross-sectional view of a media storage area of the console assembly along line 4-4 of FIG. 3 in accordance with the present invention;

FIG. 5 is a cross-sectional view of the media storage area and console assembly with the console lid shown in a closed position; and

FIG. 6 is a cross-sectional view of the media storage area and console assembly with the console lid moved to an opened position.

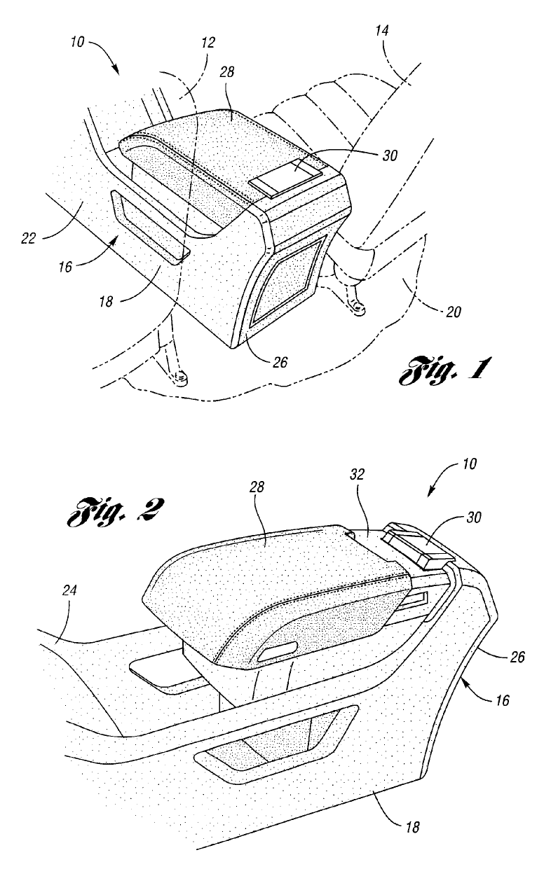

### DETAILED DESCRIPTION OF THE PREFERRED EMBODIMENT(S)

Referring now to the Figures, a console assembly for use in the passenger seating area of a motor vehicle in accordance with the present invention is disclosed. It is understood that the restraint system may be used in either the front or rear passenger seating areas. For purposes of this disclosure, the restraint system will be installed in the front passenger seating area.

In the following description, various operating parameters and components are described for a number of constructed embodiments. These specific parameters and components are included as examples and are not meant to be limiting.

Console assembly 10 disposed between a pair of passenger seats 12, 14 in the passenger compartment of the vehicle. Console assembly 10 includes a console housing 16 having a base 18 configured to secure the console assembly 10 to the floor 20 of the passenger seating area of the vehicle. The base of console housing may also be connected to one or more vehicle seats. A pair of side surfaces 22 extend generally upward from base 18 and are preferably disposed adjacent the pair of passenger seats 12, 14. It is understood that the console housing may be positioned anywhere within the passenger seating area of the vehicle.

Console housing 16 further includes a front surface 24 disposed generally adjacent a dashboard (not shown) or other forward portion of the vehicle and an opposing rear surface 26 accessible by occupants in a rear passenger seating area of the vehicle. The console housing 16 may also include a variety of storage compartments or areas, such as storage bins or cup holders, formed on an external portion of the console housing.

An armrest 28 is pivotally connected to console housing 16 by a hinge 30. Armrest 28 is pivotally connected to the console housing 16 and is positionable between a lowered position disposed at least partially adjacent a top surface 36 of the console housing 16 and a raised position disposed away from the top surface 36 of console housing 16. It should also be understood that the armrest can be easily arranged to pivot about the front, rear or sides of the console housing based on design and aesthetic requirements.

In one aspect of the present invention shown in FIG. 2, armrest 28 is slidably mounted to a receiving portion 32. Receiving portion 32 allows armrest 28 to be adjusted forward and rearward relative to the console housing by the occupants of the passenger seating area. In another aspect of the present invention, the armrest may include a two piece assembly, wherein the lower portion includes a storage area and the upper portion or armrest closeout section is secured adjacent the storage area.

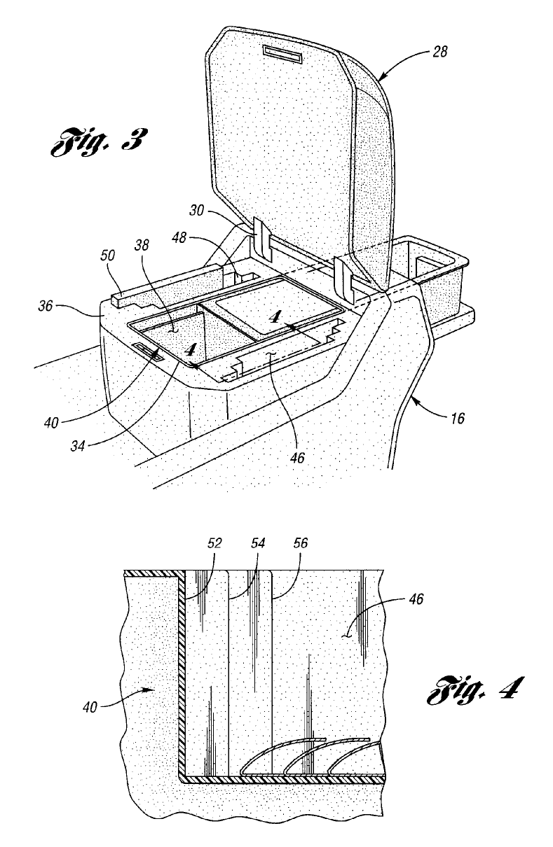

Referring now to FIG. 3, armrest 28 extends at least partially over an opening 34 in a top surface 36 of the console housing 16. Opening 34 communicates with a storage cavity 38 extending below the top surface 36 of the console housing 16. Storage cavity 38 may comprise a storage bin or include a cavity configured to provide access to one or more storage modules 40 housed therein. In one aspect of the present invention, armrest 28 is connected to storage module 40 by hinge 30. Alternatively, the armrest may be connected to a portion of the console housing. It is understood that the armrest may be hinged to the front, rear or sides of the closeout section, allowing the console lid to pivot a number of directions based on design and aesthetic requirements.

Referring additionally now to FIGS. 4-6, storage module 40 includes a housing 42 having a recess 44 formed therein. Recess 44 is configured to receive and secure a variety of passenger personal items, such as purses, cell phones or sunglasses. It is also contemplated that vehicle components, such as garage door openers, media components and the like may be positioned within the storage module housing.

In one aspect of the present invention, the console housing may contain a channel in a rear surface of the console housing. The recess formed in the storage module housing comprises a storage bin that is adjustable rearward relative to the console housing through channel. This concept is disclosed in copending U.S. patent application Ser. No.______, filed ______, entitled “Console Assembly for a Vehicle,” which is hereby incorporated by reference.

Storage module housing 42 also includes one or more media storage areas 46. Media storage areas 46 comprise generally vertical slots 48 formed in the housing 42 adapted to receive standard sized media containers or cases 50, such as DVD cases or compact disc (CD) jewel boxes. Slots 48 may be shaped to receive media cases 50 either lengthwise or widthwise.

It is understood that the quantity, size, location and shape of slots 48 may be designed to accommodate specific types of media. For example, as shown in FIG. 3, media storage area 46 is configured to receive CD jewel boxes. However, it is understood that the media storage area may be configured to receive DVD media cases.

It is also contemplated that the media storage area may be provided in a variety of storage compartments within the passenger seating area of a vehicle. For example, media storage area may be disposed in an opening in the instrument panel or in an opening in an armrest in a door trim panel or quarter trim panel. A lid or cover will typically accompany these openings to force jewel boxes downward into slots in the media storage area.

In a preferred aspect of the present invention shown in FIGS. 3-6, media storage area 46 includes a plurality of slots 52, 54, 56 offset longitudinally in storage module housing 42 relative to one another configured to receive media cases 50. It is also understood that the plurality of slots could be aligned in the console housing while accomplishing the same objectives of the present invention. Sidewalls 58 of slots 52, 54, 56 are sized to receive media cases 50 such that the containers would not rattle side to side while positioned in the storage area 46. It is also desirable to place the slots immediately adjacent each other such that the discs are retained within the storage area.

At least one spring member 60 is mounted on a bottom surface 62 of media storage area 46. Spring member 60 cooperates with slots 48 to receive and present media cases 50 to occupants in the passenger seating area of the vehicle. In one aspect of the present invention, spring member 60 is a single leaf spring extending across slots 48. In another aspect of the present invention, a leaf springs is provided with each slot. It is understood that other types of springs may be used in a similar fashion to accomplish the same objectives.

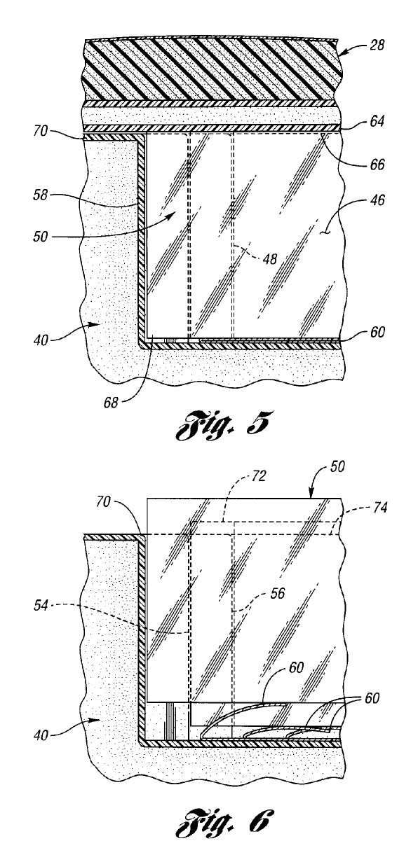

Referring now to FIGS. 5 and 6, a description of the storage and removal of the media storage containers in the storage module of the console assembly is described in greater detail. FIG. 5 illustrates the armrest 28 of console assembly 10 in a closed or stored position. When the armrest 28 is closed, a lower surface 64 of the armrest is disposed adjacent the top surface 70 of storage area 46 of storage module housing 40.

The lower surface 64 of armrest engages an upper surface 66 of the media case 50, forcing the case 50 downward into storage area 46. As the case 50 travel downward through storage area 46, the bottom surface 68 of media case 50 compresses spring member 60 such that the upper surface 66 of case 50 is substantially flush with the top surface 70 of storage area 46. When the console lid is closed, the media cases 50 are generally secured in the storage area 46 to eliminate rattles of the cases 50 in storage area 46 during vehicle operation.

As illustrated in FIG. 6, when the armrest (not shown) of the console assembly is moved from a stored or closed position to an open position, media cases 50 are urged upward from the stored position to an exposed position by spring members 60. To remove media case 50 from the storage area 46 of storage module housing 40, an occupant depresses adjacent media cases 72, 74 downward into slots 54, 56 such that media case 50 extends above the top surface 70 of the storage area 46.

In another aspect of the present invention, the spring members comprise locking-type spring devices which can lock when depressed. In this aspect of the invention, the media cases may be disposed within the storage area until an occupant pushes down on the individual media case to cause spring device to unlock, thereby pushing media case upward through slot above the top surface of the storage module.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A console assembly for use in a passenger seating area of a vehicle, the console assembly comprising:
a console housing configured for installment in the passenger seating area having a storage cavity defined therein;
an armrest pivotally connected to the console housing movable between a first position extending at least partially over a top surface of the console housing and at least one opened position;
a storage module disposed at least partially within the storage cavity having a housing configured to receive one or more items;
at least one storage area formed in the storage module housing,
wherein the at least one storage area includes a plurality of slots configured to receive and secure removable media storage cases when the armrest is positioned at least partially adjacent the top surface of the console housing.

2. The console assembly of claim 1 wherein the console housing is disposed between a pair of front passenger seats in the passenger seating area.

3. The console assembly of claim 1 wherein the console housing includes a base, a front surface, opposing side surfaces, a rear surface defining the storage area of the console housing.

4. The console assembly of claim 1 wherein the plurality of slots extend generally vertically through the storage module housing.

5. The console assembly of claim 4 wherein the plurality of slots are offset longitudinally in storage module housing.

6. The console assembly of claim 1 further comprising at least one spring member mounted to a bottom surface of the storage area.

7. The console assembly of claim 6 wherein at least one spring member causes the removable media cases to be moved from a stored position received within the storage area to an exposed position extending at least partially above the storage area when the armrest is moved to the opened position.

8. The console assembly of claim 6 wherein at least one spring member further comprises a leaf spring provided in each of the plurality of slots in the storage area.

9. The console assembly of claim 6 wherein at least one spring comprises a single leaf spring extending across each of the plurality of slots in the storage area.

10. The console assembly of claim 1 wherein the armrest further comprises a closeout section, a receiving portion operatively connected to the closeout section and a console lid slidably connected to the receiving portion.

11. The console assembly of claim 1 further comprising one or more storage compartments formed in an external portion of the console housing.

12. A console assembly disposed between a pair of front passenger seats in a passenger seating area of a vehicle, the console assembly comprising:
a console housing configured for installment in the passenger seating area having a base, a front surface, opposing side surfaces, a rear surface and a storage cavity defined therein;
a storage module having a housing disposed in the console housing adjacent the storage cavity;
an armrest pivotally connected to the storage module movable between a first position extending at least partially over a top surface of the storage module housing and at least one second position;
at least one storage area formed in the storage module housing having a plurality of generally vertical slots configured to releasably secure one or more media cases; and
at least one spring member mounted to a bottom surface of the storage area,
wherein the at least one spring member causes the removable media storage cases to be moved from a stored position received within the storage area to an exposed position extending at least partially above the storage area when the armrest is moved to the opened position.

13. The console assembly of claim 12 wherein the storage area is configured to receive and secure the removable media storage cases when the armrest is positioned at least partially adjacent the top surface of the console housing.

14. The console assembly of claim 12 wherein the plurality of slots are offset longitudinally in storage module housing.

15. The console assembly of claim 12 wherein at least one spring member further comprises a leaf spring provided in each of the plurality of slots in the storage area.

16. The console assembly of claim 12 wherein at least one spring comprises a single leaf spring extending across each of the plurality of slots in the storage area.

17. A storage assembly configured for use in a passenger seating area of a vehicle, the storage assembly comprising:
a storage module having a housing;
a cover pivotally connected to the storage module movable between a first position extending at least partially over a top surface of the storage module and at least one opened position;
at least one storage area formed in the storage module housing having a plurality of generally vertical slots configured to releasably secure one or more media cases;
at least one spring member mounted to a bottom surface of the storage area,
wherein the at least one spring member causes the removable media storage cases to be moved from a stored position received within the storage area to an exposed position extending at least partially above the storage area when the armrest is moved to the opened position.

18. The storage assembly of claim 17 wherein the storage module comprises a console housing disposed in a center console arrangement between a pair of passenger seats.

19. The storage assembly of claim 17 wherein the storage module comprises a armrest in a door trim panel.

20. The storage assembly of claim 17 wherein the storage module comprises an opening in a quarter trim panel of the passenger seating area.
